(19) United States
(12) Patent Application Publication
(10) Pub. No.: US 2008/0060008 A1
(43) Pub. Date: Mar. 6, 2008

(54) METHOD OF SEARCHING PROGRAM FOR USER WITHOUT HAVING TO ENTER KEYWORDS

(75) Inventors: Guofu Wang, Beijing (CN); Lin Li, Beijing (CN)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 11/855,172

(22) Filed: Sep. 14, 2007

Related U.S. Application Data
(63) Continuation of application No. PCT/CN2006/000543, filed on Mar. 29, 2006.

(30) Foreign Application Priority Data
Mar. 30, 2005 (CN) 200510062909.0
Mar. 29, 2006 (CN) PCTCN2006000543

(51) Int. Cl. H04N 5/445; G06F 3/00

(52) U.S. Cl. 725/39; 725/46

(57) ABSTRACT

A method for generating keywords of TV programs in Electronic Program Guide (EPG) includes generating keyword information describing characteristics of TV programs in EPG in accordance with the digital video broadcast service information specification, editing service information containing keywords of TV programs at transmitting side, and transmitting the EPG containing the generated keyword information. An easy-to-use program search experience is available to users, upon the condition that the electronic programs are edited in complying with DVB-SI standard specification, the keyword information is configured according to the invention, and EPG interpretation applications at the receiver side further extract and analyze the keyword information accordingly.

This application is a continuation of China PCT Application CN2006/000543, filed Mar. 29, 2006 the entire contents of which are hereby incorporated herein by reference.

### BACKGROUND OF THE INVENTION

1. Field of Invention

The present invention relates to a method of searching digital television (TV) programs, more specifically, searching TV programs through Electronic Program Guide (EPG) for users without having to enter keywords by users.

2. Description of Prior Art

Digital TVs have developed quickly in recent years. Services relating to digital TVs also increase greatly. In the case where a large amount of program information is provided to users through a wired network by the program providers, the providers face a problem how to allow users to find the services and information easily and quickly when watching high quality programs. EPG is an application produced for running in integrated receiver decoder (IRD) at user terminals to easily obtain information for users. EPG provides human-machine interactive interface which is composed of characters, graphs, and pictures to users and navigates TV programs and various services. Users can know relevant information including the time during which the programs are played, the time when the programs are played, and overview of the programs etc. by using the EPG, search and access the programs.

As the increase of the number of channels which are available to TV viewers, the categories and contents of the programs which can be obtained from the channels also increase. It is difficult for the TV viewers to select the programs they like when they watch the programs because so much information is provided.

At present, generally, the TV viewers search programs through the EPG by selecting the categories of programs. The available range of the categories for TV viewers is wide and there are many matched results. Therefore the matched results are not so precise. In another way, the TV viewers have to enter keywords to search the programs. In this case, it is necessary to provide entering method to the TV viewers. The operation to enter keywords is complicated and not easy.

It is possible that a TV viewer try to find the programs which are similar to the program he is watching when he thinks that the watched program is good. The operation to search the programs by entering keywords is not easy. Another way to search the same category of programs is carried out by using the categories of programs which is watched. However, the precision of search is not enough only by using category because preference of the TV viewers' to similar programs may not only depend on the category of the programs. For example, a TV viewer is interested in soccer program. The TV plays relevant to soccer and the League match of soccer fall into different program categories. The TV viewer may be interested in both programs and considers that both programs share common features. In this case, it is difficult to accurately obtain similar programs by keywords indicating the main features of the program. For the same example, both the TV plays relevant to soccer and the League match of soccer have the keyword, i.e., “soccer”.

Therefore, a method is needed for searching similar programs for users based on keywords without having to entering keywords so that the interested programs can be found only by clicking button once or more times.

### SUMMARY OF THE INVENTION

It is therefore an object of the present invention to provide a method of searching programs in digital TVs which is capable of searching relatively similar programs based on keywords of the programs for users without having to entering keywords. The method can be applied to the Digital Video Broadcasting (DVB) standard.

In order to achieve above object, according to an aspect of the present invention, there is provided a method of generating keywords of TV programs in Electronic Program Guide (EPG), comprising steps of generating keyword information describing characteristics of TV programs in EPG in accordance with the digital video broadcast service information specification; editing service information containing said keywords of TV programs at transmitting side; and transmitting the EPG containing the said generated keyword information.

According to another aspect of the present invention, there is provided a method of searching TV programs through keyword information by using Electronic Program Guide (EPG), comprising the steps of the EPG searches a event information table corresponding to the TV programs based on the TV programs designated by users; the EPG extracts the keyword information of said TV program from a extended event descriptor of said event information table; matching the extracted keyword information of said TV program with the keyword information of other TV programs, and obtaining the TV program information similar to the TV program.

According to still another aspect of the present invention, there is provided a method of searching TV programs through keyword information by using Electronic Program Guide (EPG), comprising the steps of users click function keys to designate a TV program to be watched; EPG searches a event information table corresponding to the TV programs based on the TV program designated by users; the EPG extracts the keyword information of said TV program from a extended event descriptor of said event information table; matching the extracted keyword information of said TV program with the keyword information of other TV programs, and obtaining the TV program information similar to the TV program.

According to the present invention, it provides users with a method for easily searching TV program on the condition that the electronic program information is edited in conformity with the DVB-SI specification, the keyword information of the TV programs is provided based on the solution of the present invention, and the EPG interpreting program extracts and analyzes the keyword information of the TV programs based on the solution of the present invention.

### BRIEF DESCRIPTION OF THE DRAWINGS

The above and other objects, features and advantages of the present invention will be apparent by the following descriptions of the preferred embodiment of the present invention in conjunction with the accompanying drawing, in which:

FIG. 1 is a flow chart showing the process of searching programs according to an embodiment of the present invention.

### DETAILED DESCRIPTION OF PREFERRED EMBODIMENT

The embodiment of the present invention will be described in detailed in connection with the figure. Unnecessary functions and details for the invention are omitted in the description in order to prevent the confused understandings to the present invention.

In order to understand the invention better, the composition of the electric program guidance information will be described first.

The electric program guide information (hereinafter, referred to as EPG information) is composed of two parts: basic EPG information and Extended EPG information. The basic EPG information is referred to EPG information which can be described by using network information table (NIT), bouquet association table (BAT), service description table (SDT), event information table (EIT) in the digital broadcasting service information specification. The extended EPG information is referred to EPG information which is transferred by using data carousel, except for the basic EPG information. The entrance to the information is described by the EPG map table (EMT). The content of the information is encapsulated into a file system having a hierarchical directory structure, which is referred to as extended EGP content information (XECI). An EPG system can include at least the basic EGP information.

The NIT, BAT, SDT, EIT and EMT tables in the digital broadcast service information specification can be represented by dividing into one or more segments, and are then inserted into the transmission stream (TS) packet. Segment is a syntax structure for mapping service information (SI) table and EPG information table to the TS packet. The information is compliant with specific segment syntax structure defined in the Specification. The segment can be directly mapped into the TS packet. The segment can start from the beginning of payload of the TS packet. However, this is not necessary because the beginning of the first segment for the payload of the TS packet is specified by a pointer_field (pointer field).

In digital TVs, all of the audio, video and data information must be packaged based on the MPEG-2 standard after they are encoded and before entering the transmission system so as to form a TS packet having a fixed length. That is, the length of the packet is 188 bytes or 204 bytes. As for the packets having the same length, if no guide information is present, it is impossible for IRD to find a desired code stream. Therefore, it defines program specification information (PSI) in the MPEG-2 standard, for auto-setting and guiding IRD to decode.

The PSI information is composed of the following four tables: (1) program association table (PAT); (2) program map table (PMT); (3) network information table (NIT); (4) condition access table (CAT).

The PSI information in the MPEG-2 provides information about the composition of related program and interrelationship of each other so that a receiver IRD can analyze multiplexed transmission stream. However, the information is still not sufficient in practice. It is impossible for the information to provide the names of the programs, the beginning time and duration time of the programs, and the additional information of the program. For this reason, SI service information is extendedly defined in the DVB. Basically, the PSI information is related to actual stream (AS), whereas the SI information can include some tasks and event information which is not included in the actual stream, so that the users can make more selection and know more other task information.

Different from the four tables defined in the PSI, it defines nine tables in the SI, wherein the most important tables constituting the basic EPG information include the network information table (NIT), the service description table (SDT) and the event information table (EIT). The information transmitted by the SI table is given by descriptors.

Each of the descriptors starts with a descriptor_tag (for uniquely identifying the type of the descriptor) and a descriptor_length. The different descriptors are used to describe information carried by different SI tables.

As for search for similar programs based on keywords, the selection for the keywords is very important. The most precise result can be matched by precisely generalizing the keywords reflecting the main features of the TV programs. The program providers should know the contents and generalize the programs in best way in the program contents. Therefore, it is very convenient to the user if the program providers can provide the keywords of the programs. Currently, it does not provide a location dedicated for sending the keyword information of the programs in the DVB-SI. According to an embodiment of the invention, it provides a solution that includes the keyword information of the programs in the DVB-SI. In the solution, an EIT table is selected to include the keyword information of the TV programs. However, it should be noted that the present invention is not limited to this, the keyword information of the transmitted program can also be included by other modes.

The DVB-SI Specification includes many information tables. The event information table (EIT) includes data related to events or programs, such as the name of the event, the beginning time, duration, the type of the event. It is very proper to include the keywords of the TV programs in the EIT table as the information is related to the TV programs directly.

The EIT table includes reserved fields for placing various descriptors to store additional information. There are two ways for sending the keywords of the programs. One way is to send the keyword information by extending the existing descriptors. The other way is to add a user-defined descriptor dedicated for sending the keyword information. In view of compatibility, the cost can be reduced by extending the existing descriptors, for it is not necessary for the receiver side to perform additional processes to obtain the keyword information. However, it should be noted that the present invention is not limited to this, the mode which adds the user-defined descriptors can also be used.

By comparison, it is more proper to give the keyword information by using an extended event descriptor. Further, if the information for an event has a length exceeding 256 bytes, more than one relevant extended event descriptor can be used to perform description. The text information can be classified into two columns, one for the description for the entry and the other for the content of the entry. Typically, such a structure can be applied to give a list of actors or actresses or other staffs etc. For example, if the entry description field is related to a “producer”, the name for the producer can be given in the entry content field.

Next, the modes for expressing the keywords of the TV programs in the extended event descriptor according to the present invention are described.

The extended event descriptors in the EIT table give detailed text description for the event. The syntax for the extended event descriptors in the DVB-SI Specification is given as follows:

| extended_event_descriptor( ){ | | |
|---|---|---|
| descriptor_tag | 8 | uimsbf |
| descriptor_length | 8 | uimsbf |
| descriptor_number | 4 | uimsbf |
| last_descriptor_number | 4 | uimsbf |
| ISO 639-2_language_code | 24 | bslbr |
| Length_of_items | 8 | uimsbf |
| for(i=0;i<N;i++){ | | |

| | | |
|---|---|---|
| item_description_length | 8 | uimsbf |
| for(j=0;j<N;j++){ | | |

| | | |
|---|---|---|
| item_description_char | 8 | uimsbf |

| } | | |
|---|---|---|
| item_length | 8 | uimsbf |
| for(j=0;j<N;j++){ | | |

| | | |
|---|---|---|
| item_char | 8 | uimsbf |

}
}

}

Based on the syntax for the extended event descriptor, the parameters such as type (descriptor_tag), length (descriptor_length), number (descriptor_number) and voice (ISO 639-2_language_code) of the event can be given.

In order to include the keyword information of TV programs in the extended event descriptors, following mode can be adopted according to the embodiment of the present invention.

1. The keywords are divided into different levels based on their importance. The first level is the highest one. Each of the levels has one or more keywords. For example, the keywords for a League match of soccer may relate to soccer, League Match, sports and the like. The “soccer” and “League Match” can be used as the first level of keywords. That is, the descriptive words most directly related to the content or type of the TV programs are used as the first level of keywords.

2.The entry information in the extended event descriptor are used to record the keyword information. The description for the entry (item_description_length and item_descriptor_char) is “keyword n”, wherein n is a number indicating the nth level of the keywords. Herein, the content of the entry (item and item_char) is the nth level of the keywords. Each of the entries defines a keyword. When there are multiple keywords for one level, the level may correspond to multiple entries. Herein, the description for the entry remains unchanged. The content for the entry is different keywords of this level.

For example, there are two extended event descriptors for describing a certain League match of the soccer. The first descriptor describes a list of the persons of producing the program of the League match of the soccer, and the second one describes the keywords of the present program. Herein, it is assumed that the first level of the keywords is “soccer” and “League match”, and the second level of the keywords is “sports”. The second extended event descriptor for describing the keywords is shown in the table 1 as below.

TABLE 1

| Field | Value | Note |
|---|---|---|
| descriptor_tag | 0x4E | extended event descriptor |
| descriptor_length | 0x36 | 54 bytes in the data section |
| | | following the field |
| descriptor_number | 0x01 | indicating that the current |
| | | descriptor is the second |
| | | relevant extended event |
| | | descriptor (incrementing by 1 |
| | | from 0x00) |
| last_descriptor_number | 0x01 | indicating the sequence |
| | | number of the last extended |
| | | event descriptor |
| ISO 639-2_language_code | Chi | indicating that the language |
| | | of the text description is |
| | | Chinese |
| length_of_items | 0x31 | the total length for the |
| | | subsequent entries is 49 in |
| | | unit of byte |
| Item_description_length | 0x09 | the length is 9 |
| Item_description_char | Keyword 1 | indicating the first level of |
| | | keywords. The value for |
| | | the first byte of this field |
| | | is 0x13, which indicates |
| | | the encoding on the |
| | | following “keyword 1” is |
| | | performed based on |
| | | GB2312 and its extended |
| | | collection, thus the total |
| | | length is 9. |
| Item_length | 0x05 | the length is 5 |
| Item_char | soccer | the first level of keywords |
| | | “soccer” is give. The value |
| | | of the first byte of the field |
| | | is 0x13 [symbol] |
| Item_description_length | 0x09 | length is 9 |
| Item_description_char | Keyword 1 | indicating the first level |
| | | keywords. The first byte of |
| | | this field has the value 0x13, |
| | | indicating that the following |
| | | “keyword 1” is coded |
| | | according to GB2312 and its |
| | | extended set. Therefore, the |
| | | length is 9. |
| Item_length | 0x05 | length is 5 |
| Item_char | League | setting the first level |
| | match | keywords “League match”. |
| | | The first byte of the field |
| | | has the value 0x13. |
| Item_description_length | 0x09 | length is 9 |
| Item_description_char | Keyword 2 | indicating the 2nd level |
| | | keywords. The first byte of |
| | | this field has the value 0x13, |
| | | indicating that the following |
| | | “keyword 2” is coded |
| | | according to GB2312 and its |
| | | extended set. Therefore, the |
| | | length is 9. |
| Item_length | 0x05 | Length is 5 |
| Item_char | sports | setting the 2nd level |
| | | keyword “sports”. The first |
| | | byte of the field has the |
| | | value 0x13. |
| Text_length | 0x00 | the text of un-listed items |
| | | has the length 0, i.e. the text |
| | | of the items not listed. |

Next, the extended event descriptor, which are necessarily generated according to the invention, will be further explained.

Description_tag: value is 0x4E, indicating extended event descriptor.

Description_length: value is 0x36, indicating that the data section following this field has 54 bytes.

Description_number: value is 0x01, indicating that currently-relevant 2^{nd} extended event descriptor (obtained through increasing 0x00 by 1)

Last_description_number: value is 0x01, indicating that the sequential number of the last extended event descriptor.

ISO_{—}639-2_language_code: value is chi, indicating that the language for text description is Chinese.

Length_of_items: value is 0x31, indicating that the total length of the subsequent entries is 49, in unit of byte.

Item_description_length: value is 0x09, indicating that length is 9.

Item_description_char: value is keyword 1, indicating the first level keywords. The value of the first byte of the field is 0x13, indicating that the following “keyword 1” is coded according to GB2312 and its extended set, therefore, the length is 9.

Item_length: value is 0x05, indicating that length is 5.

Item_char: value is soccer, indicating that the first level keyword is set as “soccer”. The value of the first byte of the field is 0x13.

Item_description_length: value is 0x09, indicating that length is 9.

Item_description_char: value is keyword 1, indicating the first level keywords. The value of the first byte of the field is 0x13, indicating that the following “keyword 1” is coded according to GB2312 and its extended set, therefore, the length is 9.

Item_length: value is 0x05, indicating that length is 5.

Item_char: value is League match, indicating that the first level keyword is set as “League match”. The value of the first byte of the field is 0x13.

Item_description_length: value is 0x09, indicating that length is 9.

Item_description_char: value is keyword 2, indicating the second level keywords. The value of the first byte of the field is 0x13, indicating that the following “keyword 2” is coded according to GB2312 and its extended set, therefore, the length is 9.

Item_length: value is 0x05, indicating that length is 5.

Item_char: value is sports, indicating that the second level keyword is set as “sports”. The value of the first byte of the field is 0x13.

text_length: value is 0x00, indicating that the text of un-listed items has the length 0, i.e. the text of the items not listed.

In the above description, the format of extended event descriptor is described by using “soccer”, “League match” and “sports” as the first and second level keywords respectively.

When the sender edits SI information in the format of the above-mentioned descriptor, and the receiver parses the SI information in the same format, EPG interprets it accordingly. After the keywords are generated, the EPG including the generated keywords is sent via digital broadcasting. The receiver may easily extract the keyword information of the TV programs so as to enable the user to search the programs without entering the keywords.

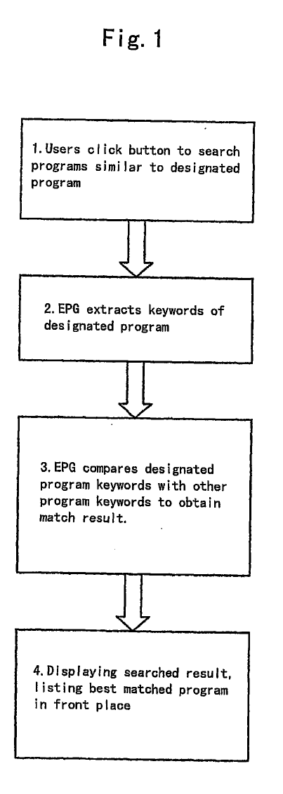

Next, with reference to FIG. 1, explanation is made to the process of the method for searching relevant programs based on the extended event descriptor of the invention. The method of the invention enables the user to search relevant programs easily without entering keywords.

First, in Step S11, a user may get all the programs similar to the designated program by using the EPG or by a single click of a function key on the remote controller (subject to the specific of the implementation of the method), in case the user watches a program and finds it interesting, then intends to search for similar program, or in case the user while browsing the EPG finds an interesting program but the program is not showed at the time, then the user intends to search for the similarly interesting program showed at the time, or in case the user intends to search for the programs similar to those that he watched before and found interesting.

Then, in Step S12, according to the format of the descriptor for configuring the keywords of TV programs as explained above, EPG extracts the keyword information from the EIT extended event descriptor of the user-designated program. Afterwards, in Step S13, EPG matches the keyword information of other programs with the extracted keyword information of the program, to get all the programs similar to or relevant to the program. Lastly, in Step S14, EPG lists all the programs according to the level of similarity based on the level of the keyword and the amount of the keywords successfully matched. The best matched result is listed on the top of the list. In displaying the result, the keywords used in the match are also shown for the convenience of further search.

For example, while watching a live broadcasting of a soccer game, the user intends to search for similar programs while watch or after while, he may press the search button of the relevant programs. At the time, the programs relevant to soccer, such as live broadcasts, news, interviews, and commentary programs, are all listed on the screen. The sequence of the list is according to the level of the match of the keywords. This means in this case the live broadcast programs are listed on the top. In case what the user is interested in is exactly live broadcast, his one click gets the expected result. In case he is interested in soccer related commentary programs, he may select commentary program and again click the search key of relevant programs, to get further search results. In the whole process, the user does the search for programs without the trouble of additional manual enters. Moreover, it is a step by step approach which gets close to the best match results.

A solution is proposed based on the invention that DVB-SI (digital video broadcast service information) technical specification include a description for the keywords of TV programs. The solution may be applied in DVB (digital video broadcast) which has been widely adopted. In other words, keyword information is transmitted by using the descriptor defined in the DVB-SI specification. When a user finds a program he likes, no matter if it is a program he is watching or if it is a program selected by the user while browsing the EPG, the user can search for all programs similar to the program by one click of the function key. The search operation is conducted in a way that the analyzing application at the receiver side, such as an EPG application, obtains keyword information from the SI information.

By implementing the solution of the invention, an easy-to-use program search experience is available to users, as long as the electronic programs are edited in complying with DVB-SI standard specification, the keyword information is configured according to the invention, and EPG interpretation application at the receiver side further extracts and analyzes the keyword information according to the invention.

The invention has been illustrated in conjunction with the preferred embodiment. It should be understood by a person in the art that various changes, additions, substitution and variations are possible without departing from the spirit of the invention. And the scope of the protection should not be limited by the embodiment and should be defined by the claims.

1. A method for generating keywords of TV programs in Electronic Program Guide (EPG), comprising the steps of:
generating keyword information describing characteristics of TV programs in EPG in accordance with the digital video broadcast service information specification;
editing service information contained said keywords of TV programs at transmitting side; and
transmitting the EPG containing the said generated keyword information.

2. The method according to claim 1, wherein the keyword information is stored in an event information table of digital video broadcast service information.

3. The method according to claim 1 or 2, wherein the step of generating keyword information includes the step of defining the levels of importance of the keywords.

4. The method according to claim 3, wherein a level contains multiple entries in case multiple keywords are included in the level.

5. The method according to claim 1 or 2, wherein the parameters of said keywords are configured by using extended event descriptors.

6. A method for searching TV programs through keyword information by using Electronic Program Guide (EPG), comprising the steps of:
searching, by the EPG an event information table corresponding to the TV programs based on the TV programs designated by users;
extracting, by the EPG, the keyword information of said TV program from an extended event descriptor of said event information table;
matching the extracted keyword information of said TV program with the keyword information of other TV programs, and obtaining the TV program information similar to said TV program.

7. The method according to claim 6, further comprising the step of the EPG listing the searched similar TV programs in sequence of the level of similarity based on the level of the successfully matched keywords, and displaying the result.

8. The method according to claim 6, further comprising the step of the EPG listing the searched similar TV programs in sequence of the level of similarity based on the amount of the successfully matched keywords, and displaying the result.

9. The method according to claim 6, further comprising the step of the EPG listing the searched similar TV programs in sequence of the level of similarity based on the level of and the amount of the successfully match keywords, and displaying the result.

10. A method for searching TV programs through keyword information by using Electronic Program Guide (EPG), comprising the steps of
activating, by the user, user function keys to designate a TV program to be watched;
searching, by the EPG, an event information table corresponding to the TV programs based on the TV programs designated by users;
extracting, by the EPG, the keyword information of said TV program from an extended event descriptor of said event information table;
matching the extracted keyword information of said TV program with the keyword information of other TV programs, and obtaining the TV program information similar to said TV program.

11. The method according to claim 10, further comprising the step of listing, by the EPG, the searched similar TV programs in sequence of the level of similarity based on the level of and/or the amount of the successfully match keywords, and displays the result.
